(19) United States
(12) Patent Application Publication
(10) Pub. No.: US 2025/0047521 A1
(43) Pub. Date: Feb. 6, 2025

(54) CONTROLLER AREA NETWORK EARLY WAKE PULSE

(71) Applicant: Ford Global Technologies, LLC, Dearborn, MI (US)

(72) Inventors: Chieh-Kai Chang, Hazel Park, MI (US); Muhammad Uzair, Kanata (CA); Ming Tai, Kanata (CA); Gwendolyn Ald, Dearborn, MI (US); Philipp Heusel, Kanata (CA)

(21) Appl. No.: 18/364,186

(22) Filed: Aug. 2, 2023

(51) Int. Cl. H04L 12/40

(52) U.S. Cl. CPC H04L 12/4013; H04L 2012/40215; H04L 2012/40273

(57) ABSTRACT

Gateway software is initialized responsive to receipt of a data frame to a first vehicle bus of a plurality of vehicle buses, the data frame configured to be routed to a second vehicle bus of the plurality of vehicle buses. During completion of the initialization of the gateway software, a WUP generator is used to send a WUP along the second vehicle bus. Responsive to the completion of the initialization of the gateway software, the gateway software is used to route the data frame over the second vehicle bus.

### TECHNICAL FIELD

Aspects of the present disclosure generally relate to a controller area network (CAN) early wake pulse, which may be used to reduce electrical system startup time.

### BACKGROUND

CAN is a vehicle bus standard designed to allow microcontrollers and devices to communicate with one another. A CAN frame is a unit of data that is transmitted on the CAN bus. Aspects of the physical and electrical layer of the CAN bus are defined in International Standards Organization (ISO) standard 11898-1. Aspects of the data link layer of the CAN bus are defined in ISO 11898-2. Aspects of the application layer of the CAN bus are defined in ISO 11898-3.

### SUMMARY

In one or more illustrative examples, a system for implementing an early wake pulse for a vehicle network includes a networked device, in communication with a plurality of electronic control units (ECUs) over a plurality of vehicle buses, the networked device including gateway software configured to route data frames between the plurality of vehicle buses and a wake-up pulse (WUP) generator configured to generate a WUP while the gateway software is initialized.

In one or more illustrative examples, a method for implementing an early wake pulse for a vehicle network includes initializing gateway software of a networked device responsive to receipt of a data frame to a first vehicle bus of a plurality of vehicle buses, the data frame configured to be routed to at least a second vehicle bus of the plurality of vehicle buses; before completion of the initializing of the gateway software, using a WUP generator to send a WUP along the at least second vehicle bus; and responsive to the completion of the initializing of the gateway software, routing the data frame over the at least second vehicle bus.

In one or more illustrative examples, a non-transitory computer readable medium comprising instructions for implementing an early wake pulse for a vehicle network that, when executed by one or more processors of a networked device, cause the networked device to perform operations including to initialize gateway software responsive to receipt of a data frame to a first vehicle bus of a plurality of vehicle buses, the data frame configured to be routed to at least a second vehicle bus of the plurality of vehicle buses; before completion of the initialize of the gateway software, use a WUP generator to send a WUP along the at least second vehicle bus; and responsive to the completion of the initialize of the gateway software, route the data frame over the at least second vehicle bus.

### BRIEF DESCRIPTION OF THE DRAWINGS

FIG. 1 illustrates an example system including a central gateway configured for implementing a CAN early wake pulse;

FIG. 2A illustrates a first electronic control unit sending an active frame over a first CAN bus to the central gateway;

FIG. 2B illustrates the central gateway sending a wake-up pulse over a second CAN bus to which a second electronic control unit is connected;

FIG. 2C illustrates the central gateway forwarding the active frame to the second electronic control unit;

FIG. 3 illustrates an example simplified illustration of a wake-up pulse; and

FIG. 4 illustrates an example process for implementing a CAN early wake pulse.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications.

A vehicle may implement a data architecture having a central gateway connected to a plurality of ECUs over various vehicle buses. As the vehicle may include more than one CAN bus, the central gateway may serve as a CAN frame and signal gateway router to ensure ECUs on different CAN buses can wake and communicate with one other.

A user may provide input to a vehicle to wake up a vehicle electrical system. This input may trigger the vehicle to wake an ECU. In turn, the awakened ECU may activate its connected CAN bus to communicate with other ECUs. For example, if the user presses the brake pedal, the vehicle may perform a power mode status change, security checks, a high voltage contactor close, and/or indicate propulsive power is available. Or, if the user approaches the vehicle with a key, the vehicle may activate exterior and interior lighting, cause mirror and power running board movement, and/or activate an external sounder. Or, if the user presses an interior hard switch to release the rear gate, the gate latch may be released. Each of these operations may require communication across a chain of vehicle ECUs which must be awakened. Thus, this communication may involve passing information through the central gateway.

Some use cases may require trigger-to-reaction times to be within a maximum time budget. In one example, this budget may be less than 250 ms. These reaction times may involve the CAN gateway as a part of the sequence, especially due to central compute and zonal architecture network topology trends. Yet, the CAN gateway function readiness timing from a sleep state may increase because of the added software content of the gateway and the number of CAN buses in the overall CAN network topology. The longer readiness timing means that may be less margin for other ECUs to wake and respond, which may increase the difficulty in meeting use case timing expectations in responding to the user input.

One possibility to increase wakeup speed is to add hardwire wake lines, to bypass CAN gateway readiness timing, by connecting particular wake lines from one ECU to another ECU. However, such additional hardware adds physical expense and only solve latency on a case-by-case basis.

As discussed in detail herein, a simple software approach may be used to create excitation pulses into a designated vehicle bus while the central gateway is still completing its wake sequence. These pulses are referenced herein as an early wake pulse. This solution not only achieves the timing goals, but also require no added hardwire or any additional hardware changes within central gateway and/or the other ECUs on the CAN network.

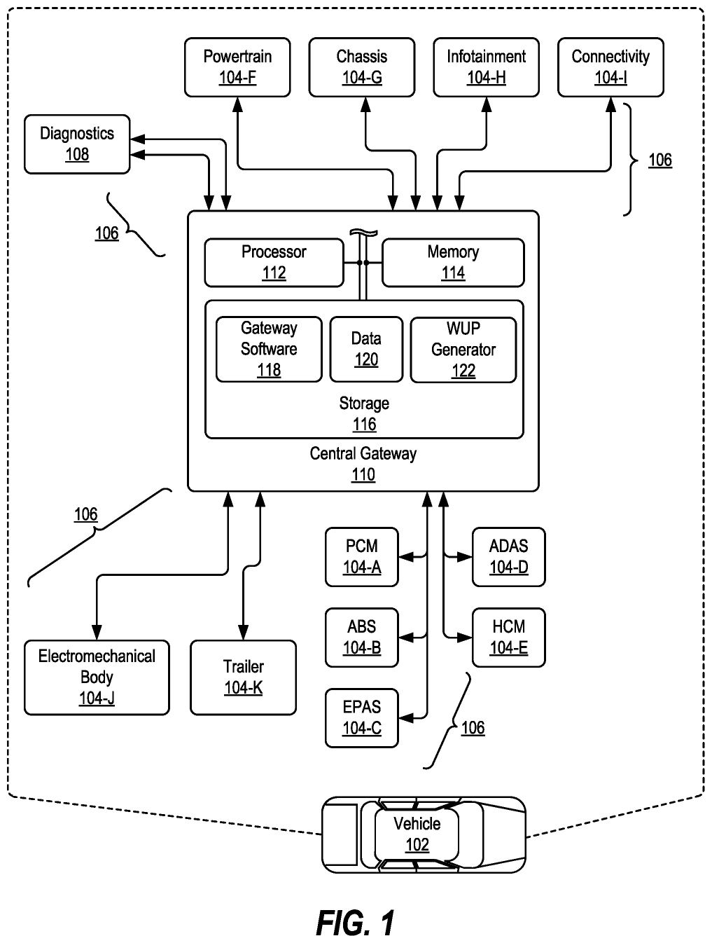

FIG. 1 illustrates an example system 100 including a central gateway 110 configured for implementing a CAN early wake pulse. The central gateway 110 may be connected to a plurality of ECUs 104 over one or more vehicle buses 106. The central gateway 110 may also include one or more diagnostic ports 108. The central gateway 110 may include a processor 112, a memory 114, and a computer-readable storage medium 116 for gateway software 118 and/or data 120. While an example system 100 is shown in FIG. 1, the example components as illustrated are not intended to be limiting. Indeed, the system 100 may have more or fewer components, and additional or alternative components and/or implementations may be used.

The vehicle 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors. In another example, the vehicle 102 may be a pure electric vehicle driven by electric motors only.

The vehicle 102 may include a plurality of ECUs 104 configured to perform and manage various vehicle 102 functions under the power of the vehicle battery and/or drivetrain. As depicted, the example vehicle ECUs 104 are represented as discrete ECUs 104-A through 104-H. However, the vehicle ECUs 104 may share physical hardware, firmware, and/or software, such that the functionality from multiple ECUs 104 may be integrated into a single ECU 104 or distributed across a plurality of ECUs 104. The vehicle ECUs 104 may include various vehicle 102 components configured to receive updates of associated software, firmware, or configuration settings.

As some non-limiting vehicle ECUs 104 examples: a powertrain control module (PCM) 104-A may be configured to control engine and transmission components; an antilock brake system (ABS) 104-B controller configured to control brake and traction control components; an electric power-assisted steering (EPAS) 104-C controller configured to control steering assistance and adjust pull or drift compensation functions; advanced driver assistance systems (ADAS) 104-D such as adaptive cruise control or automate braking; and a headlamp control module (HCM) 104-E configured to control light on/off settings. The ECUs 104 may also include other powertrain 104-F or chassis 104-G components, an infotainment system 104-H configured to support voice command and BLUETOOTH interfaces with the driver and driver carry-on devices (e.g., the SYNC system provided by Ford Motor Company of Dearborn, MI), a connectivity controller 104-I such as a telematics control unit (TCU) configured to utilize an embedded modem to access networked devices external to the vehicle 102, electromechanical body controllers 104-J such as window or lock actuators, and trailer controller 104-K components such as light control and sensor data to support connected trailers.

The vehicle bus 106 may include various methods of communication available between the vehicle ECUs 104. The vehicle bus 106 may also support communication between the central gateway 110 and the vehicle ECUs 104. These vehicle buses 106 may be implemented as a series of segments of wiring. For instance, a vehicle bus 106 may include a plurality of segments of wiring from the central gateway 110 to an end location. As some non-limiting examples, the vehicle bus 106 may be a vehicle CAN, an Ethernet network, or a media oriented system transfer (MOST) network. The CAN network or networks may be various types, including, but not limited to, high speed CAN (HS-CAN) having a data capacity of up to 500 kbps, mid-speed CAN (MS-CAN) having a data capacity of up to 125 kbps, and/or CAN flexible data rate (FD-CAN) having a data capacity of up to 2000 kbps or higher. It should be noted that the illustrated bus topology is merely an example, and other numbers and arrangements of vehicle buses 106 may be used.

The vehicle 102 may further include diagnostic ports 108 that may be used by external devices to monitor the status of the vehicle 102. In an example, the diagnostic port 108 may be an on-board diagnostics (OBD) port connected to the vehicle bus 106. A user may connect a dongle, code reader, or other scan device to the diagnostic port 108, and may use the connection provided by the diagnostic port 108 to gain access to messages traversing the vehicle bus 106. Once connected, a user may utilize the connected scan device to capture diagnostic codes, monitor vehicle health, or, in some cases, adjust vehicle settings.

The central gateway 110 may be configured to provide an electrical interface between the vehicle buses 106 used to communicate within the vehicle 102. In an example, the central gateway 110 may be configured to route signals from one CAN bus to another CAN bus. In another example, the central gateway 110 may be configured to translate signals and commands between CAN and/or in-vehicle Ethernet vehicle buses 106 connected to the central gateway 110.

As a specific detailed non-limiting example, the central gateway 110 may be connected to the powertrain 104-F components over a HS-CAN vehicle bus 106; to the chassis components 104-G, driving systems and a cluster over a second HS-CAN vehicle bus 106; to the infotainment system 104-H over a third HS-CAN vehicle bus 106; to the connectivity 104-I and Ethernet security backup systems over a fourth HS-CAN vehicle bus 106; to the electromechanical body controllers 104-J over a first MS-CAN bus; to the trailer controller 104-K and/or nodes readily accessed from the exterior of the vehicle 102 over a second MS-CAN vehicle bus 106; to a diagnostic port 108 over first and second diagnostic data vehicle bus 106 connections; to the PCM 104-A, ABS 104-B, EPAS 104-C, and other controllers over a first FD-CAN vehicle bus 106; and to the ADAS 104-D, HCM 104-E and other controllers over a second FD-CAN vehicle bus 106. For instance, the infotainment 104-H, connectivity 104-I, cluster 104-L, heads-up display 104-M, and ADAS 104-D are each connected to the central gateway 110 via separate 2-wire 100 Mbsp Ethernet vehicle buses 106. In yet another example the heads-up display 104-M may be integrated with the cluster 104-L.

The central gateway 110 may be further configured to provide computing functionality in support of the domain CAN messaging of the vehicle 102. For instance, the central gateway 110 may include one or more processors 112 configured to perform instructions, commands, and other routines in support of the processes described herein. In an example, the central gateway 110 may be configured to execute instructions of gateway software 118 loaded to a memory 114 of the central gateway 110 from a computer-readable storage medium 116 of the central gateway 110. The computer-readable storage medium 116 (also referred to as a processor-readable medium or storage) includes any non-transitory medium (e.g., a tangible medium) that participates in providing instructions or other data that may be read by the processor 112 of the central gateway 110. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, etc.

The gateway software 118 may include software code programmed to support the operation of the central gateway 110 discussed in detail herein. For instance, the gateway software 118 may include software code to route information between the various vehicle buses 106 connected to the central gateway 110. The data 120 may include information for use in support of the operation of the gateway software 118. In an example, the data 120 may include a mapping of which ECU 104 is located or addressable from which of the vehicle buses 106.

In an example, the central gateway 110 may further be configured to execute instructions of a wake-up pulse generator 122. The WUP generator 122 include dedicated software to facilitate the wakeup of the ECUs 104 during the wakeup sequence of the gateway software 118 of the central gateway 110. The WUP generator 122 software may be executed before the gateway software 118 has completed its initialization.

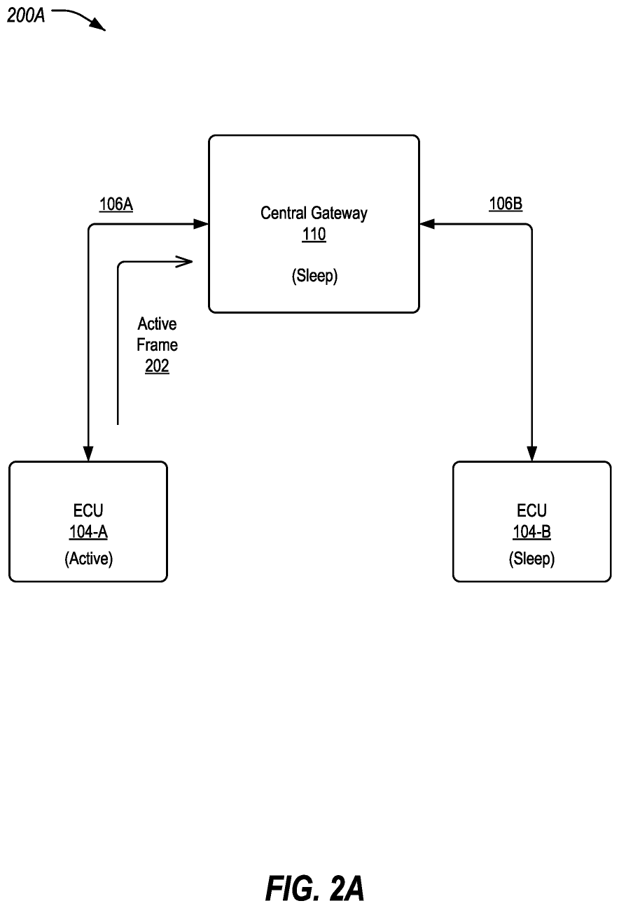

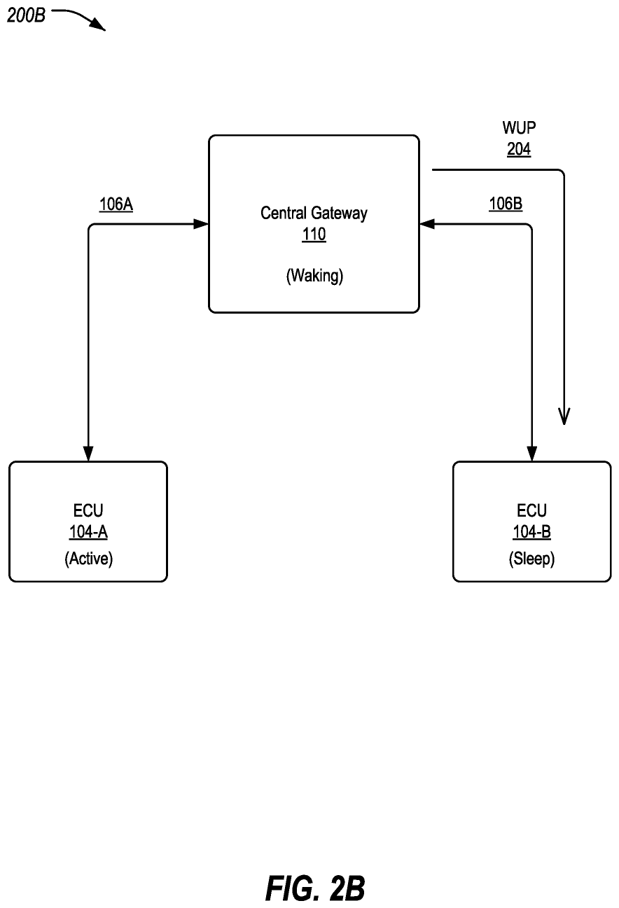

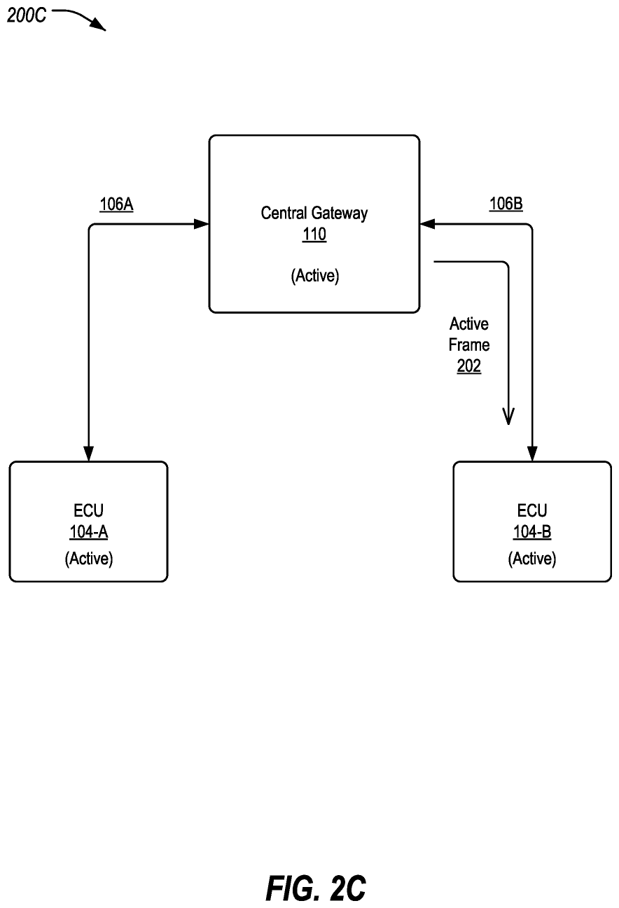

FIGS. 2A-2C collectively illustrate an example wakeup operation. In this non-limiting example, the active first ECU 104-A activates the first CAN bus 106-A, and desires to wake up the second ECU 104-B on the second CAN bus 106-B.

In a traditional CAN wakeup sequence, the central gateway 110 recognizes the active first CAN bus 106-A. Once the gateway software 118 is awakened, the central gateway 110 applies its CAN gateway function in its gateway software 118 to route a CAN data frame 202 from the first CAN bus 106-A to the second CAN bus 106-B. The sleeping second ECU 104-B on the second CAN bus 106-B recognizes the data frame 202 and thus start waking up its internal electrical system. However, such an approach requires the central gateway 110 to fully wake before the data frame 202 can be sent from the central gateway 110 to the second ECU 104-B.

In the enhanced CAN wakeup sequence shown in FIGS. 2A-2C, the central gateway 110 recognizes the active first CAN bus 106-A and, while the gateway software 118 initializes, the wake-up pulse generator 122 causes the second ECU 104-B to begin to wake.

FIG. 2A illustrates an example 200A of a first ECU 104-A sending a data frame 202 over a first CAN bus 106-A to the central gateway 110. This data frame 202 may be sent by the first ECU 104-A, responsive to the first ECU 104-A waking. This waking may, for instance, occur responsive to user input as discussed above, such as user approach to the vehicle 102, pressing the brake pedal, pressing a gate open button, etc.

FIG. 2B illustrates an example 200B of the central gateway 110 sending a WUP 204 over a second CAN bus 106-B to which a second ECU 104-B is connected. Notably, a sleeping ECU 104 does not require a full CAN frame to wake; instead, the ECU 104 simply requires signals that can be recognized as being a WUP 204. Thus, data frame 202 recognition may be achieved by the CAN transceiver of the ECUs 104 and/or the central gateway 110, by sensing a particular predefined CAN bus signal logic transition patterns of the WUP 204.

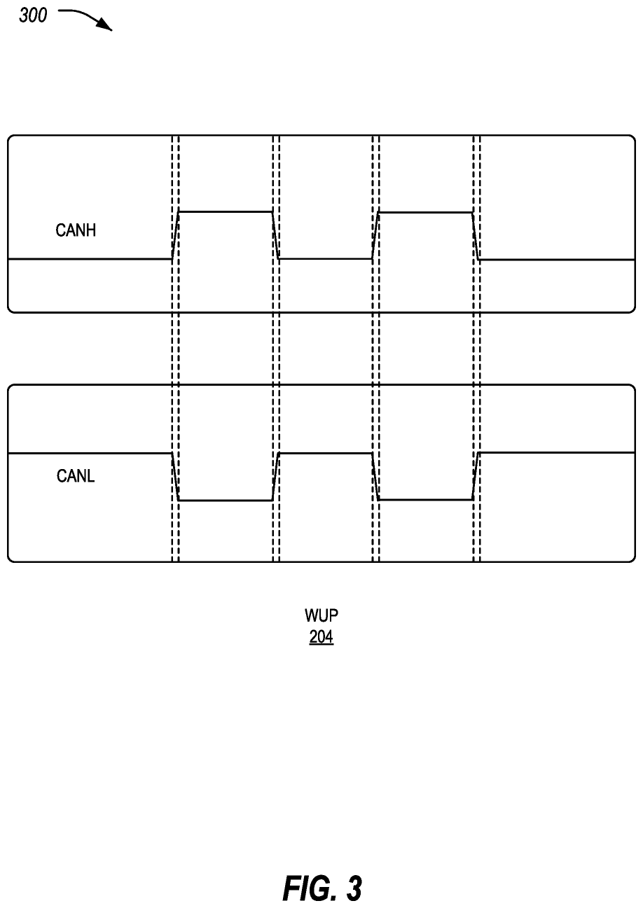

FIG. 3 illustrates an example 300 simplified illustration of a WUP 204. As shown, the specific pattern of the WUP 204 involves a predefined transition pattern. This pattern is defined as a Dominant-Recessive-Dominant pulse sequence with certain timing limits. Further details of these transition patterns are described in detail in the ISO 11898-2:2016 Wake-up Pattern specification, which is incorporated herein by reference in its entirety.

Significantly, these pulses do not contain valid data as a full CAN frame would require. Thus, the central gateway 110 may be programmed to generate the WUP 204 without having to load and initialize the full CAN gateway software 118. For instance, the WUP generator 122 of the central gateway 110 may utilize the input of the CAN transceiver that drives messages from the central gateway 110 to the vehicle buses 106 on the CANH and CANL pins. The WUP generator 122 may set the CAN TXD pin mode to general purpose input/output (GPIO) in the output direction, and then toggle the TXD pin to send signal through the CAN transceivers to the vehicle buses 106. The TXD pin operates by feeding the signal into a comparator that determines if the signal is a low or a high based on a reference threshold. Based on this result the comparator controls the bus driver circuitry to either drive CANH and CANL (for a low on TXD) or not drive and leave the CAN bus at the recessive level (e.g., high on TXD).

It should be noted that while the Dominant-Recessive-Dominant pulse sequence is used for CAN, the WUP generator 122 may be configured to generate different types of WUP 204 to wake different types of vehicle bus 106 other than CAN. In another example, for an Ethernet bus, the central gateway 110 may instead generate a wake on LAN (WOL) pulse to allow an ECU 104 connected by Ethernet to begin to wake up, e.g., via magic packet detection, custom pattern detection, etc.

Returning to FIG. 2B, and with continued reference to FIG. 3, this WUP 204 may be sent by the WUP generator 122 of the central gateway 110 responsive to receipt of the data frame 202 by the central gateway 110. As the WUP generator 122 involves simple software code, the WUP generator 122 may activate and produce the WUP 204 well in advance of the full bootup of the gateway software 118. The WUP 204 may therefore allow the second ECU 104-B to wake up to be ready to receive the data frame 202 as forwarded by the central gateway 110. Accordingly, the receiving second ECU 104-B is able to begin its wakeup process earlier instead of waiting for actual routed CAN data frame 202 from the central gateway 110. Significantly, this early wakeup may be performed without CAN physical layer or peripheral hardware changes.

FIG. 2C illustrates the central gateway 110 forwarding the data frame 202 to the second ECU 104-B. Once the central gateway 110 is awake, and the second ECU 104-B is awakened via the WUP 204, the data frame 202 may be sent over the second CAN bus 106-B to be received and processed by the second ECU 104-B.

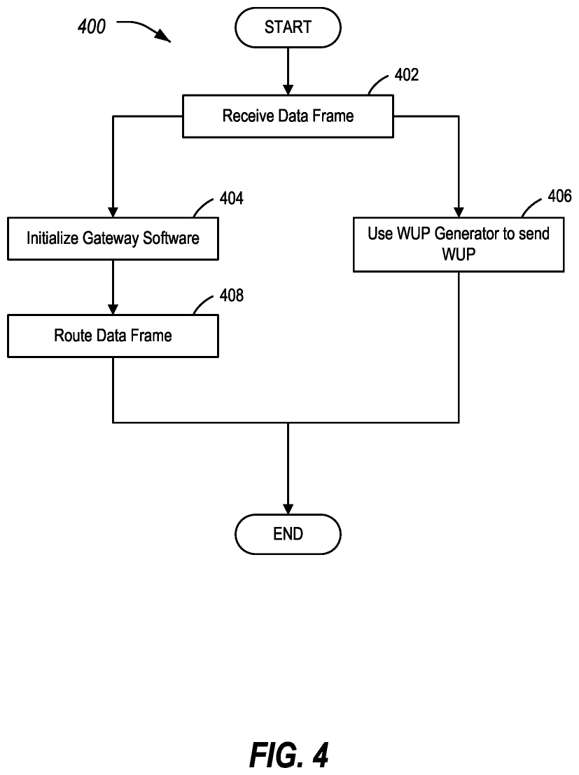

FIG. 4 illustrates an example process 400 for implementing a CAN early wake pulse. In an example, the process 400 may be performed by the central gateway 110 in the context of the system 100 discussed in detail herein. For example, the central gateway 110 may be in communication with a plurality of ECUs 104 over a plurality of vehicle buses 106 and may include gateway software 118 configured to route data frames 202 between the plurality of vehicle buses 106 and a WUP 204 generator configured to generate the WUP 204 before and/or while the gateway software 118 is being initialized.

At operation 402, the central gateway 110 receives a data frame 202. In an example, the data frame 202 may be received from a first vehicle bus 106 of the plurality of vehicle buses 106, where the data frame 202 is configured to be routed to a second vehicle bus 106 of the plurality of vehicle buses 106. For instance, the data frame 202 may be received from a first ECU 104-A of the plurality of ECUs 104 and be addressed to a second ECU 104-B of the plurality of ECUs 104. The first ECU 104-A may be connected to the central gateway 110 over a first CAN bus 106-A, while the second ECU 104-B may be connected to the central gateway 110 over a second CAN bus 106-B.

At operation 404, the central gateway 110 initializes the gateway software 118. Initialization of the gateway software 118 may allow the central gateway 110 to route data frames 202 between the various vehicle buses 106 connected to the central gateway 110. The gateway software 118 may make use of the data 120 to map which ECU 104 is located (or addressable) from which of the vehicle buses 106.

At operation 406, the central gateway 110 uses the WUP generator 122 to send a WUP 204. For instance, during or otherwise before completion of the initialization of the gateway software 118, the central gateway 110 may utilize the WUP generator 122 to send the WUP 204 along the second vehicle bus 106. In an example, the WUP generator 122 may generate the WUP 204 over a CAN vehicle bus 106 using the TXD pin of a transceiver of the central gateway 110. As one possibility, the WUP generator 122 may toggle the TXD pin to generate a dominant-recessive-dominant pulse sequence for the WUP 204 in accordance with the ISO 11898-2:2016 Wake-up Pattern specification.

At operation 408, the central gateway 110 routes the data frame 202. For example, responsive to completion of the initialization of the gateway software 118, the central gateway 110 may send the data frame 202 over the second vehicle bus 106. After operation 408, the process 400 ends.

Thus, specific excitation pulses that can be recognized as WUP 204 on a CAN bus may be created by the central gateway 110 in the early stage of the wake sequence while the full gateway software 118 stack is still being loaded and the CAN gateway function is not yet functional. A sleeping ECU 104 may recognize the pulses and start waking up internal electrical system instead of waiting for a data frame 202 to be routed and arrive.

The implementation and software involved in the WUP generator 122 is simple and independent to other software stack, so it can be executed much faster than actual CAN gateway function. No hardwire wake line or any physical ECU or network hardware change is needed compared to an added hardwire wake line solution (e.g. Ignition, Accessory lines). For CAN, this approach may be based on ISO 11898-2:2016 specification, so the produced WUP 204 may be recognized by any off-the-shelf CAN transceivers (e.g., as embedded in ECUs 104 or otherwise) having WUP 204 recognition capability.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for implementing an early wake pulse for a vehicle network, comprising:
a networked device, in communication with a plurality of electronic control units (ECUs) over a plurality of vehicle buses, the networked device including gateway software configured to route data frames between the plurality of vehicle buses and a wake-up pulse (WUP) generator configured to generate a WUP while the gateway software is being initialized.

2. The system of claim 1, wherein the networked device is configured to:
begin initialization of the gateway software responsive to receipt of a data frame to a first vehicle bus of the plurality of vehicle buses, the data frame configured to be routed to at least a second vehicle bus of the plurality of vehicle buses;
before completion of the initialization of the gateway software, utilize the WUP generator to send the WUP along the at least second vehicle bus; and
responsive to the completion of the initialization of the gateway software, route the data frame over the at least second vehicle bus.

3. The system of claim 2, wherein the data frame is received from a first ECU of the plurality of ECUs and is addressed to a second ECU of the plurality of ECUs.

4. The system of claim 2, wherein, subsequent to the gateway software being initialized, the networked device is configured to utilize a mapping of the ECUs to the vehicle buses to determine onto which of the plurality of vehicle buses to route the data frame.

5. The system of claim 1, wherein the WUP generator is configured to generate the WUP over a controller area network (CAN) bus using a TXD pin of a transceiver of the networked device.

6. The system of claim 5, wherein the WUP generator is configured to toggle the TXD pin to generate a dominant-recessive-dominant pulse sequence for the WUP in accordance with a wake-up pattern specification as defined in International Standards Organization (ISO) 11898-2:2016.

7. The system of claim 1, wherein the networked device is a central gateway of a vehicle.

8. The system of claim 1, wherein the plurality of vehicle buses includes one or more controller area network (CAN) buses.

9. A method for implementing an early wake pulse for a vehicle network, comprising:
initializing gateway software of a networked device responsive to receipt of a data frame to a first vehicle bus of a plurality of vehicle buses, the data frame configured to be routed to at least a second vehicle bus of the plurality of vehicle buses;
before completion of the initializing of the gateway software, using a WUP generator to send a WUP along the at least second vehicle bus; and
responsive to the completion of the initializing of the gateway software, routing the data frame over the at least second vehicle bus.

10. The method of claim 9, wherein the data frame is received from a first ECU of a plurality of ECUs and is addressed to at least a second ECU of the plurality of ECUs.

11. The method of claim 10, wherein, subsequent to the gateway software being initialized, utilize a mapping of the ECUs to the vehicle buses to determine onto which of the plurality of vehicle buses to route the data frame.

12. The method of claim 9, further comprising generating, using the WUP generator, the WUP over a controller area network (CAN) bus using a TXD pin of a transceiver of the networked device.

13. The method of claim 12, further comprising toggling the TXD pin by the WUP generator to generate a dominant-recessive-dominant pulse sequence for the WUP in accordance with a wake-up pattern specification as defined in International Standards Organization (ISO) 11898-2:2016.

14. The method of claim 9, wherein the networked device is a central gateway of a vehicle.

15. A non-transitory computer readable medium comprising instructions for implementing an early wake pulse for a vehicle network that, when executed by one or more processors of a networked device, cause the networked device to perform operations including to:
initialize gateway software responsive to receipt of a data frame to a first vehicle bus of a plurality of vehicle buses, the data frame configured to be routed to at least a second vehicle bus of the plurality of vehicle buses;
before completion of the initialize of the gateway software, use a WUP generator to send a WUP along the at least second vehicle bus; and
responsive to the completion of the initialize of the gateway software, route the data frame over the at least second vehicle bus.

16. The medium of claim 15, wherein the data frame is received from a first ECU of a plurality of ECUs and is addressed to at least a second ECU of the plurality of ECUs.

17. The medium of claim 16, wherein the medium further comprises instructions that, when executed by the one or more processors of the networked device, cause the networked device to, subsequent to the gateway software being initialized, utilize a mapping of the ECUs to the vehicle buses to determine onto which of the plurality of vehicle buses to route the data frame.

18. The medium of claim 15, wherein the medium further comprises instructions that, when executed by the one or more processors of the networked device, cause the networked device to perform operations including to generate, using the WUP generator, the WUP over a controller area network (CAN) bus using a TXD pin of a transceiver of the networked device.

19. The medium of claim 18, wherein the medium further comprises instructions that, when executed by the one or more processors of the networked device, cause the networked device to perform operations including to toggle the TXD pin by the WUP generator to generate a dominant-recessive-dominant pulse sequence for the WUP in accordance with a wake-up pattern specification as defined in International Standards Organization (ISO) 11898-2:2016.

20. The medium of claim 15, where the networked device is a central gateway of a vehicle.
